(19) United States
(12) Patent Application Publication
(10) Pub. No.: US 2024/0124109 A1
(43) Pub. Date: Apr. 18, 2024

(54) OPERATION ASSISTANCE SYSTEM AND METHOD FOR SMALL WATERCRAFT

(71) Applicant: Kawasaki Motors, Ltd., Hyogo (JP)

(72) Inventors: Toshio ARAKI, Akashi-shi (JP); Kazumasa HISADA, Akashi-shi (JP); Daisuke KAWAI, Akashi-shi (JP); Shohei TERAI, Akashi-shi (JP); Takuya SAKAMOTO, Akashi-shi (JP)

(73) Assignee: Kawasaki Motors, Ltd., Hyogo (JP)

(21) Appl. No.: 17/964,909

(22) Filed: Oct. 13, 2022

(51) Int. Cl. B63B 79/30; B63B 34/10; G01C 21/20

(52) U.S. Cl. CPC B63B 79/30; B63B 34/10; G01C 21/203; G07C 5/008

(57) ABSTRACT

An operation assistance system for a small watercraft includes: a position specification unit that specifies an abnormality occurrence position, which is a position where an abnormality has occurred, when the abnormality has occurred in a small watercraft; a transmission unit that transmits information on the abnormality occurrence position specified by the position specification unit; and a processing circuit, in which the processing circuit includes a storage unit that stores information on the abnormality occurrence position transmitted from the transmission unit, and an information provision unit that creates predetermined operation assistance information based on information on the abnormality occurrence position stored in the storage unit and transmits the created operation assistance information.

### BACKGROUND

### Technical Field

The present disclosure relates to a small watercraft that slides on water.

### Background Art

As disclosed in US 2014/0030937 A1, a small watercraft capable of sliding on water such as the sea and rivers is known.

On water, visibility may deteriorate due to the influence of waves or the like. There is no clear sign or the like on water, Therefore, there is a possibility that another navigational object unintentionally enters a place where the navigational object should not enter, such as the surrounding of the small watercraft in which an abnormality has occurred.

### SUMMARY

The present disclosure has been made in view of the above circumstances, and an object thereof is to provide an operation assistance system for a small watercraft capable of assisting operation of the small watercraft.

In order to solve the above problem, an operation assistance system for a small watercraft according to one aspect of the present disclosure includes: a position specification unit that specifies an abnormality occurrence position, which is a position where an abnormality has occurred, when the abnormality has occurred in a small watercraft; a transmission unit that transmits information on the abnormality occurrence position specified by the position specification unit; and a processing circuit, in which the processing circuit includes a storage unit that stores information on the abnormality occurrence position transmitted from the transmission unit, and an information provision unit that creates predetermined operation assistance information based on information on the abnormality occurrence position stored in the storage unit and transmits the created operation assistance information.

An operation assistance method for a small watercraft according to another aspect of the present disclosure is an operation assistance method for a small watercraft, the method for assisting operation of a small watercraft using an operation assistance system including a position specification unit, a transmission unit, and a processing circuit, the method including: a step of specifying, by the position specification unit, an abnormality occurrence position which is a position where an abnormality has occurred in the small watercraft; and a step of creating, by the processing circuit, predetermined operation assistance information based on the abnormality occurrence position, and transmitting the created operation assistance information.

An operation system for a small watercraft according to another aspect of the present disclosure is an operation assistance system for a small watercraft, the system including: an area storage unit that stores a predetermined navigation prohibited area where entry of a navigational object is prohibited; an area setting unit that sets a navigation caution area around the navigation prohibited area stored in the storage unit; a current position specification unit that specifies a current position of a navigational object; a determination unit that determines whether or not the navigational object has entered the navigation caution area based on a current position of the navigational object specified by the current position specification; and a warning unit that issues a warning to a user of a navigational object that has entered the navigation caution area when the determination unit determines that the navigational object has entered the navigation caution area.

### BRIEF DESCRIPTION OF THE DRAWINGS

FIG. 1 is a schematic view illustrating an overall configuration of an operation assistance system according to an embodiment of the present disclosure.

FIG. 2 is a partially broken side view of a small watercraft according to an embodiment of the present disclosure.

FIG. 3 is a plan view of the small watercraft.

FIG. 4 is a functional block diagram illustrating a control system of the small watercraft.

FIG. 5 is a flowchart illustrating content of basic control performed by a server and a communication terminal.

FIG. 6 is a flowchart illustrating content of control performed by a controller of the small watercraft in which an abnormality has occurred.

FIG. 7 is a flowchart illustrating content of control performed by the controller of a communication terminal mounted on the small watercraft in which an abnormality has occurred.

FIG. 8 is a flowchart illustrating content of control performed by the server.

FIG. 9 is a flowchart illustrating the first half of the control performed by the controller of the communication terminal,

FIG. 10 is a flowchart illustrating the second half of the control performed by the controller of the communication terminal.

FIG. 11 is a flowchart illustrating content of control performed by the controller of the small watercraft mounted with the communication terminal that performs the control in FIGS. 9 and 10.

FIG. 12 is a display example of a display unit of the communication terminal when the small watercraft in which an abnormality has occurred is present.

FIG. 13 is a display example of an operation assistance map displayed on the display unit of the communication terminal.

FIG. 14 is a display example of the display unit of the communication terminal when the communication terminal enters a navigation caution area.

FIG. 15 is a display example of the display unit of the communication terminal when the communication terminal enters a navigation prohibited area.

FIG. 16 is a display example of the display unit of the communication terminal when the small watercraft in which an abnormality has occurred is present.

FIG. 17 is a display example of the display unit of the communication terminal when the communication terminal enters the navigation caution area when there is the small watercraft in which an abnormality has occurred.

FIG. 18 is a display example of the display unit of the communication terminal when the communication terminal enters the navigation prohibited area when there is the small watercraft in which an abnormality has occurred.

### DETAILED DESCRIPTION

An embodiment of an operation assistance system 1 for a small watercraft according to the present disclosure will be described below with reference to the drawings.

### [Overall Configuration of Operation Assistance System]

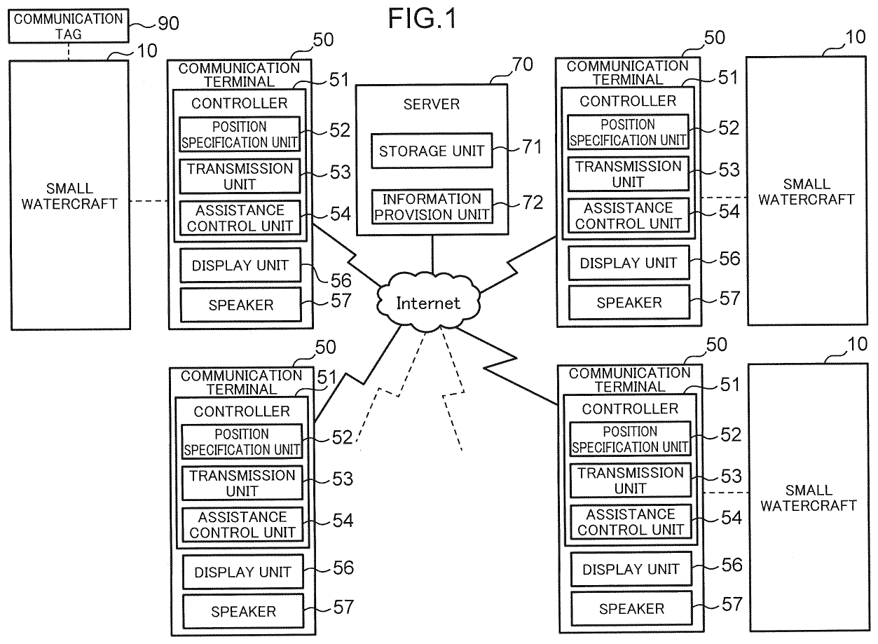

FIG. 1 is a schematic view illustrating an overall configuration of the operation assistance system 1 according to an embodiment of the present disclosure. The operation assistance system 1 includes at least one small watercraft 10, a plurality of communication terminals 50, a server 70 capable of communicating with each of the communication terminals 50, and a communication tag 90. The numbers of the communication terminals 50 and the small watercraft 10 are not limited to those in the example illustrated in FIG. 1. FIG. 1 only exemplifies some of the communication terminals 50 and some of the small watercraft 10.

The communication terminal 50 is a mobile terminal that can be carried by the user of the small watercraft 10. Fax example, the communication terminal 50 is a mobile information terminal such as a smartphone or a smartwatch. Specific configurations of the plurality of communication terminals 50 included in the operation assistance system 1 may be different from one another as long as the user of the small—watercraft 10 can carry—the communication terminals and has the functions of the communication terminals 50 described below. For example, the operation assistance system 1 may include the communication terminal 50 including a smartphone and the communication terminal 50 including a smartwatch.

The communication terminal 50 includes a controller 51, a display unit 56, and a speaker 57. The controller 51 of the communication terminal 50 is a device including, as a main part, a microcomputer including a processor (CPU) that performs calculation and memories such as a ROM and a RAM. The display unit 56 performs various displays based on a command from the controller 51. The speaker 57 outputs various sounds and voices based on a command from the controller 51. Hereinafter, the controller 51 of the communication terminal 50 will be appropriately referred to as terminal controller 51.

The terminal controller 51 directly performs wireless communication with a controller 40 of the small watercraft 10 described later without via a base station. For example, the terminal controller 51 and the controller 40 of the small watercraft 10 perform wireless communication in conformity with a short-range wireless communication standard such as Bluetooth or Wi-Fi. The terminal controller 51 wirelessly connects to a network N such as the Internet through a public circuit via a base station antenna that is a fixed facility and communicates with the server 70. Here, although there can be many mobile terminals capable of communicating with the server 70, the communication terminal 50, which is a mobile terminal included in the operation assistance system 1, is a mobile terminal registered in the server 70.

The terminal controller 51 functionally includes a position specification unit 52, a transmission unit 53, and an assistance control unit 54. The position specification unit 52 is a module that performs control of the position of the communication terminal 50. The position specification unit 52 has, for example, a GPS function, and specifies the current position of the communication terminal 50 based on a signal from an artificial satellite. The transmission unit 53 is a module that performs control regarding transmission of information (signal) to the server 70. The assistance control unit 54 is a module that performs control of assisting the operation of the small watercraft 10.

The communication tag 90 is a wireless transceiver that directly performs wireless communication with a watercraft controller 40 described later of the small watercraft 10 without via a base station. The radio wave transmitted from the communication tag 90 is a relatively weak radio wave that is recognized by the watercraft controller 40 on the condition that the separation distance from the watercraft controller 40 is equal to or less than a reference value. For example, the communication tag 90 and the watercraft controller 40 of the small watercraft 10 wirelessly communicate with each other by Bluetooth or LF long wave communication. The communication tag 90 is a small device that can be carried by a passenger of the small watercraft 10 or can be attached to a mounted object of the small watercraft 10.

The server 70 includes a processor (CPU) that performs calculation and a storage unit 71 that stores various input information. The storage unit 71 includes a memory such as a ROM and a RAM. For example, the server 70 is a cloud server, and includes a plurality of computers each including a processor and the storage unit 71. The server 70 functionally includes an information provision unit 72. The information provision unit 72 is a module that performs control of creation of operation assistance information for assisting the operation of the small watercraft 10 and surrounding navigational objects. A navigational object in the present disclosure navigates on water such as a river, a lake, and a sea. The navigational object is, for example, a watercraft including a small watercraft. The server 70 as described above corresponds to the “processing circuit” in the present disclosure.

### [Configuration of Small Watercraft]

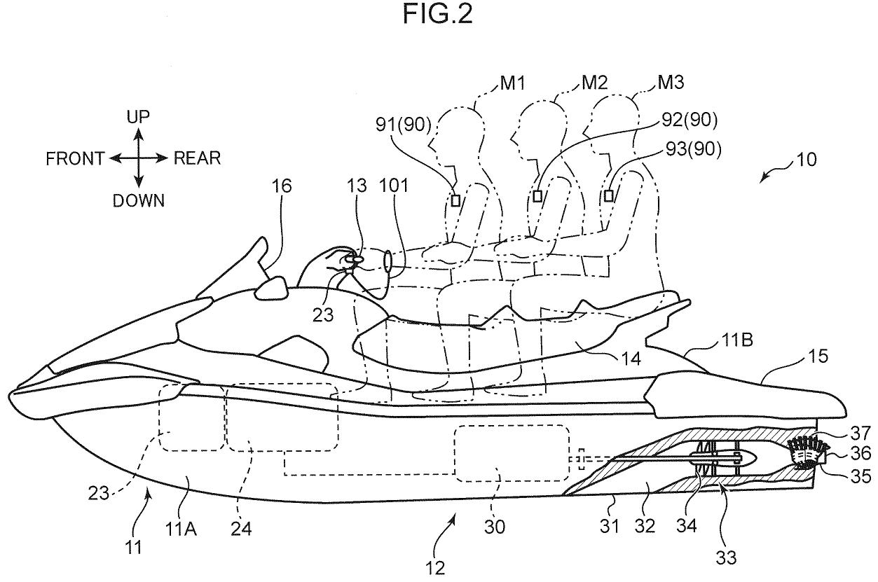

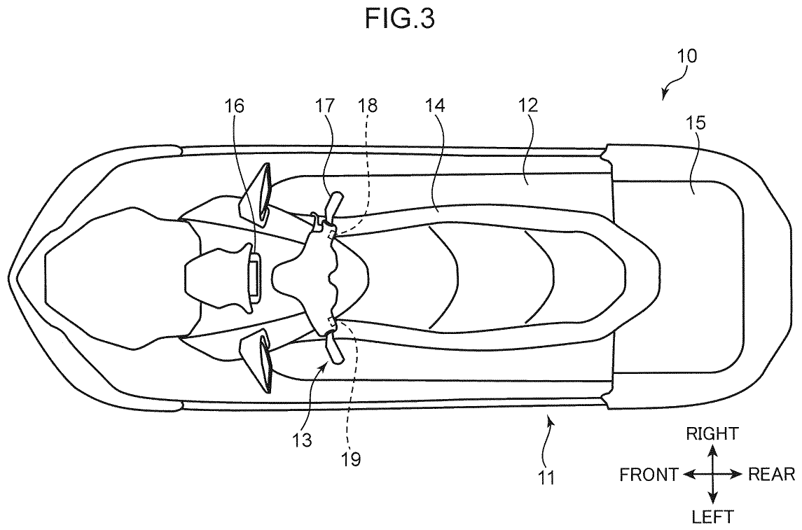

FIG. 2 is a partially broken side view of the small watercraft 10 according to an embodiment of the present disclosure. FIG. 3 is a plan view of the small watercraft 10. The small watercraft 10 is a straddle-type jet propulsion watercraft called a personal watercraft (PWC) that jets a water flow rearward and navigates in reaction to the water flow. FIGS. 2 and 3 are given indications of front, rear, left, and right directions, and these directions coincide with directions viewed from the driver on the small watercraft 10. In the following description of the configuration of the small watercraft 10, a direction viewed from the driver on board in the small watercraft 10 is used as appropriate.

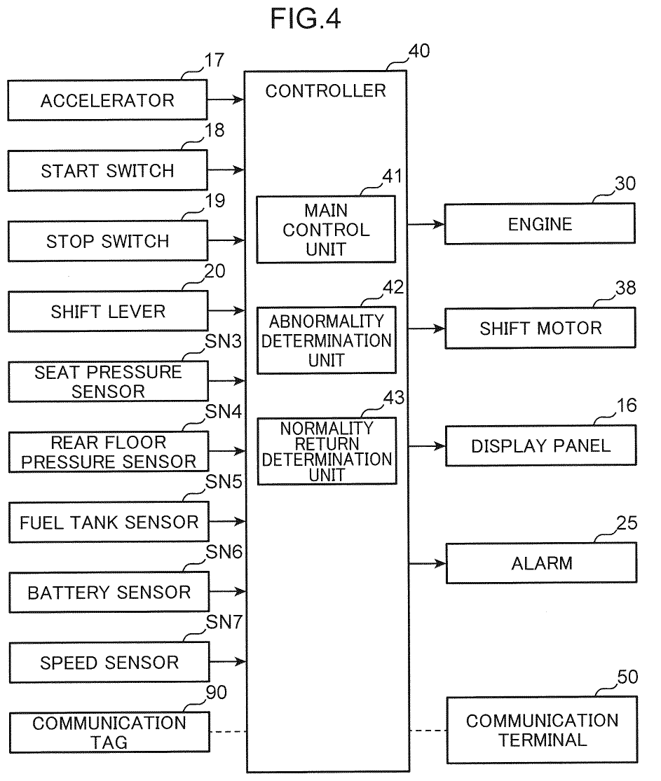

The small watercraft 10 includes a watercraft body 11, a power unit 12 that generates a propulsive force for moving the watercraft body 11 on water, and a controller 40 (FIG. 4) that controls the power unit 12.

The watercraft body 11 includes a hull 11A and a deck 11B that covers the hull 11A.

A handle 13, a seat 14, a rear floor part 15, and a display panel 16 are disposed on the deck 11B. The handle 13 is a steering handle operated by a driver M1 to steer the small watercraft 10. The handle 13 is provided in a front part of the deck 11B. The seat 14 is a seat on which the driver M1 is seated. The seat 14 is disposed at a substantially central position in front-rear and left-right of the deck 11B. The seat 14 has, for example, a size allowing three passengers to have a seat. The rear floor part 15 is a flat part positioned at rear relative to the seat 14. The rear floor part 15 is used, for example, as luggage storage for placing luggage, for example. The display panel 16 displays various types of information related to the navigation of the small watercraft 10, such as a sliding speed and a remaining amount of fuel of the small watercraft 10. As described later, the sliding speed of the small—watercraft 10 is detected by a speed sensor SN7. The remaining amount of fuel is an amount of fuel stored in a fuel tank 24 described later. As described later, the remaining amount of fuel is detected by a fuel tank sensor SN5. The display panel 16 is disposed in front of the handle 13. The deck 11B is further provided with an alarm 25 (FIG. 4) that issues a warning sound.

As mainly illustrated in FIG. 3, the handle 13 is provided with an accelerator 17, a start switch, and a stop switch 19 as operation units that can be operated by the passenger of the small watercraft 10. The accelerator 17 is a grip that is twisted for operation to adjust the sliding speed of the small watercraft 10. The start switch 18 is a switch that is pressed for operation to start an engine 30 described later of the power unit 12. The stop switch 19 is a switch that is pressed for operation to stop the engine 30.

As illustrated in FIG. 2, one end of a cable-like tether 101 is detachably connected to the stop switch 19. The tether 101 is connected to the stop switch 19 so as to be capable of activating the stop switch 19. Specifically, when the tether 101 is removed in a state where the tether 101 and the stop switch 19 are connected, that is, when the connection between the tether 101 and the stop switch 19 is released, the stop switch 19 is activated to stop the engine 30. As illustrated in FIG. 2, the other end of the tether 101 is engaged with the driver M1. Due to this, when the driver M1 falls overboard and the tether 101 falls off from the stop switch 19, the stop switch 19 is activated to stop the engine.

A rear region of a bottom surface of the hull 11A is provided with a water inlet port 31. In this region, an impeller passage 32 extending rearward with the water inlet port 31 as an inlet is formed so as to penetrate a rear part of the hull 11A in the front-rear direction. The power unit 12 applies a propulsive force to the watercraft body 11 by injecting rearward, through the impeller passage 32, water taken in from the water inlet port 31.

The power unit 12 includes the engine 30, a jet pump 33, a reverse bucket 37, a shift motor 38 (FIG. 4), and a battery 23 each accommodated inside the hull 11A.

The engine 30 is a drive source that generates a driving force for driving the jet pump 33. The fuel tank 24 is accommodated in the watercraft body 11. The engine 30 generates a driving force by burning a mixture of air and fuel supplied from the fuel tank 24. The engine 30 is, for example, a water-cooled four-stroke multicylinder engine using gasoline as fuel.

The jet pump 33 is a pump that generates a jet water flow injected rearward by pressurizing and accelerating the water taken into the impeller passage 32 from the water inlet port 31. The jet pump 33 includes an impeller 34 and a jet nozzle 35. The impeller 34 is rotationally driven by the engine 30 to generate a jet water flow. The jet nozzle 35 is a nozzle having an injection port 36 for jetting a jet water flow. The jet nozzle 35 is supported to be swingable left and right. The jet nozzle 35 is linked to the handle 13 via a cable or the like so as to turn left and right in accordance with steering of the handle 13. Left-right swing of the jet nozzle 35 changes the jetting direction of the jet water flow from the injection port 36, thereby changing the traveling direction of the small watercraft 10.

The reverse bucket 37 is arranged to be swingable in the up-down direction at an outlet of the jet pump 33. When the position of the reverse bucket 37 is in an upper forward position not covering the injection port 36, the jet water flow is jetted rearward, and the watercraft body 11 moves forward. On the other hand, when the position of the reverse bucket 37 is in the lower reverse position covering the injection port 36, the jet water flow is bent forward by the reverse bucket 37, and the watercraft body 11 moves backward. When the position of the reverse bucket 37 is in a neutral position between the forward position and the reverse position, the movement of the watercraft body 11 substantially stops.

The shift motor 38 is a motor that drives the reverse bucket 37. That is, the reverse bucket 37 is swung by the shift motor 38. The shift motor 38 is driven in response to operation of a shift lever 20 (FIG. 4) provided at the handle 13 or its vicinity.

The battery 23 supplies electric power to various electric equipment mounted on the watercraft body 11 including the shift motor 38.

### [Control System of Small Watercraft]

FIG. 4 is a functional block diagram illustrating the control system of the small watercraft 10. The controller 40 of the small watercraft 10 is a control device including, as a main part, a microcomputer including a processor (CPU) that performs calculation, memories such as a ROM and a RAM, and various input/output buses. Hereinafter, the controller 40 of the small watercraft 10 will be appropriately referred to as watercraft controller 40.

The watercraft controller 40 receives signals from the switches described above. That is, the watercraft controller 40 is electrically connected to the accelerator 17, the start switch 18, the stop switch 19, and the shift lever 20.

The watercraft body 11 is mounted with a plurality of sensors. Specifically, the watercraft body 11 is mounted with a seat pressure sensor SN3, a rear floor pressure sensor SN4, the fuel tank sensor SN5, a battery sensor SN6, and the speed sensor SN7.

The seat pressure sensor SN3 detects pressure applied to the seat 14. The rear floor pressure sensor SN4 detects pressure applied to the rear floor part 15. The fuel tank sensor SIBS detects a remaining amount of fuel, which is the amount of fuel stored in the fuel tank 24. The battery sensor SN6 detects the remaining capacity of the battery 23. The speed sensor SN7 detects the sliding speed of the watercraft body 11.

The watercraft controller 40 receives signals also from the above-described sensors. As described above, the watercraft controller 40 communicates with the communication tag 90 and the communication terminal 50, and receives signals from them. The watercraft controller 40 can individually communicate with the plurality of communication tags 90. Specifically, the radio waves emitted from the communication tags 90 are different for each communication tag 90, and the watercraft controller 40 communicates independently for each radio wave, that is, for each communication tag 90, FIG. 2 exemplifies a case where the driver M1 and two passengers (a first passenger M2 and a second passenger M3) are boarded on the small watercraft 10, and the drive M1 and the passengers M2 and M3 carry the communication tags 90 (first communication tag 91, second communication tag 92, and third communication tag 93), respectively. In the example of FIG. 2, the watercraft controller 40 individually communicates with the first communication tag 91, the second communication tag 92, and the third communication tag 93. Instead of the above, the communication tags 90 may emit the same radio waves, and the watercraft controller 40 may be configured to communicate with the plurality of communication tags 90 without recognizing the types of them.

The watercraft controller 40 is electrically connected to the engine 30, the shift motor 38, the display panel 16, and the alarm 25, and outputs a control signal to these elements. The watercraft controller 40 outputs a signal also to the communication terminal 50. Regarding control of the engine 30, the watercraft controller 40 controls output of the engine 30 and operation such as stall/stop of the engine 30 by controlling elements such as a fuel injection valve and an ignition plug included in the engine 30.

The watercraft controller 40 functionally includes a main control unit 41, an abnormality determination unit 42, and a normality return determination unit 43. The main control unit 41 is a module that mainly performs control regarding sliding operation of the small watercraft 10. The abnormality determination unit 42 is a module that performs determination as to whether or not an abnormality has occurred in the small watercraft 10. The normality return determination unit 43 is a module that performs determination, when an abnormality has occurred in the small watercraft 10, as to whether or not the abnormality has been eliminated and the small watercraft 10 has returned to a normal state.

### [Operation Assistance Processing]

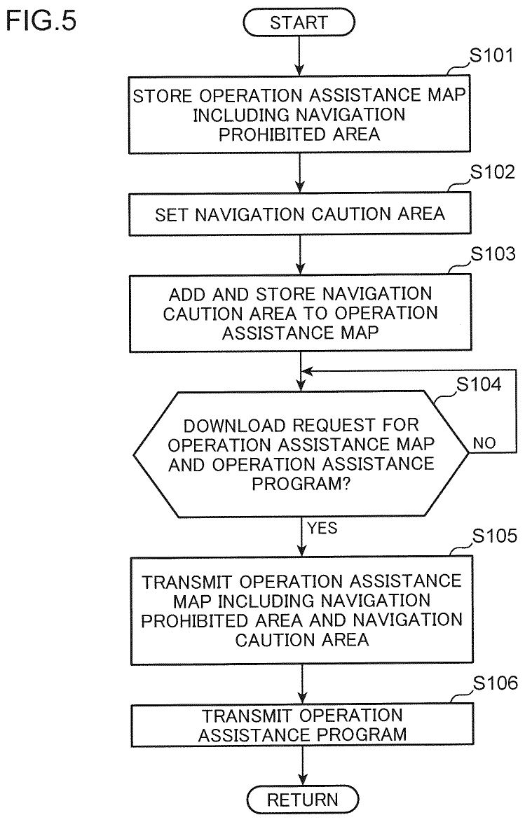

Next, the content of control performed by each element included in the operation assistance system 1 to assist the operation of the small watercraft 10 will be described with reference to flowcharts illustrated in FIGS. 5 to 12.

First, basic control performed by the server 70 and each of the communication terminals 50 will be described with reference to the flowchart of FIG. 5.

When the control in FIG. 5 is started, the storage unit 71 of the server 70 stores an operation assistance map (step S101), The operation assistance map is input to the server 70 directly or from a separate computer or the like. The operation assistance map is a map for assisting the operation of a navigational object such as the small watercraft 10. The operation assistance map includes map information of a river, a lake, and a sea through which a navigational object such as the small watercraft 10 can navigate, and coastal areas of them. The operation assistance map includes map information of a preset navigation prohibited area. The navigation prohibited area is an area where navigation of a navigational object is prohibited. For example, the navigation prohibited area is set in an area that is likely to be stranded and an area where navigation or entry is prohibited as a rule of an administration or the like. Hereinafter, this preset navigation prohibited area will be appropriately referred to as basic navigation prohibited area.

Next, the information provision unit 72 of the server 70 sets and stores an area around the stored basic navigation prohibited area as a navigation caution area where a navigational object needs to navigate carefully (step S102). For example, the information provision unit 72 sets, as a navigation caution area, an area between an outer edge of a basic navigation prohibited area and a line separated from the outer edge by a predetermined distance. Hereinafter, the navigation caution area set around the basic navigation prohibited area will be appropriately referred to as basic navigation caution area. The information provision unit 72 of the server 70 has a function of storing a navigation prohibited area in which navigation of a navigational object is prohibited and a function of setting a navigation caution area around the navigation prohibited area, and this information provision unit 72 corresponds to the “area storage unit” and the “area setting unit” in the present disclosure.

Next, the information provision unit 72 adds the basic navigation caution area to the operation assistance map and updates the operation assistance map (step S103), The storage unit 71 of the server 70 stores the updated operation assistance map (step S103).

Next, the information provision unit 72 determines whether or not a download request for the operation assistance map and an operation assistance program has been issued from the communication terminal 50 (step S104). That is, the information provision unit 72 determines whether or not there has been a request for transmitting information on the operation assistance map and the operation assistance program to the communication terminal 50 from the communication terminal 50 (step S104). Specifically, when receiving a predetermined signal from the communication terminal 50 and registering the communication terminal 50 in the server 70 as the communication terminal 50 included in the operation assistance system 1, the information provision unit 72 determines that there is a download request. The operation assistance program is a control program performed by the communication terminal 50 in order to assist the operation of a navigational object such as the small watercraft 10, and its control content will be described later.

If the determination is NO in step S104 and there is no download request for the operation assistance map, the server 70 returns to step S104.

On the other hand, if the determination is YES in step S104 and there is a download request for the operation assistance map and the operation assistance program, the information provision unit 72 transmits the operation assistance map and the operation assistance program to the communication terminal 50 (step S105). Specifically, the information provision unit 72 transmits the operation assistance map updated in step S103, that is, the operation assistance map including the basic navigation prohibited area and the basic navigation caution area to the communication terminal 50. Next, the information provision unit 72 transmits the operation assistance program to the communication terminal 50 (step S106). Here, the communication terminal 50 that has received the operation assistance map including the navigation prohibited area and the navigation caution area from the server 70 stores the operation assistance map. By receiving the operation assistance program, the communication terminal 50 (assistance control unit 54 described later) can execute the operation assistance program.

### (Control in Small Watercraft)

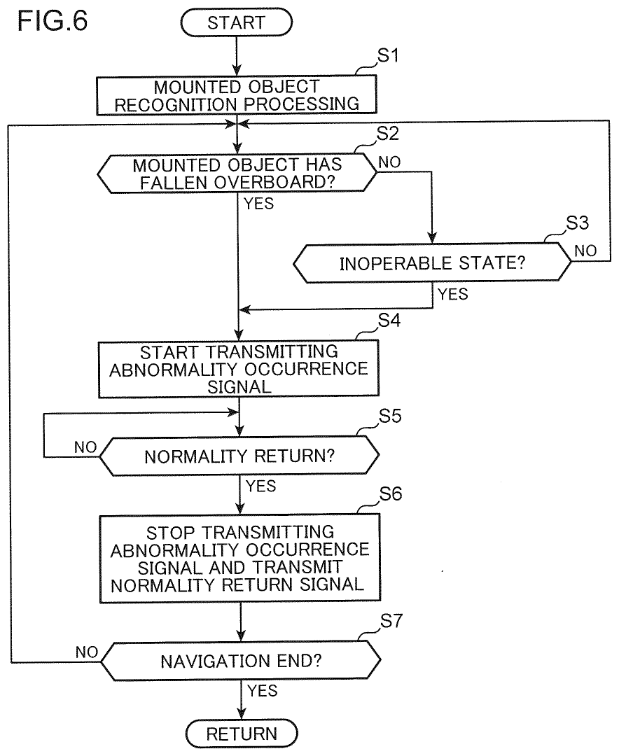

The control illustrated in the flowchart of FIG. 6 is performed by the watercraft controller 40. When the operation assistance system 1 includes a plurality of the small watercrafts 10, the watercraft controllers 40 in the small watercrafts 10 individually perform the control illustrated in FIG. 6 for the respective small watercrafts 10 mounted with the watercraft controllers 40.

As a premise of applying the control illustrated in FIG. 6, in order to enable sliding of the small watercraft 10, the driver M1 connects the tether 101 with the stop switch 19 and turns on the start switch 18 to start the engine 30. The control in FIG. 6 is started at the time point when the engine 30 is started in this way.

When the control in FIG. 6 is started, the abnormality determination unit 42 of the watercraft controller 40 performs recognition processing for the mounted object (step S1). This processing is performed during the sliding preparation period immediately after the start of the engine 30. The sliding preparation period is a period from the start of the engine 30 to the start of sliding of the small watercraft 10 by the operation of the accelerator 17.

Specifically, the abnormality determination unit 42 stores, as an initial seat pressure, the pressure applied to the seat 14 detected by the seat pressure sensor SN3. The abnormality determination unit 42 stores, as an initial rear floor pressure, the pressure applied to the rear floor part 15 detected by the rear floor pressure sensor SN4. The abnormality determination unit 42 determines whether or not the communication tag 90 and the watercraft controller 40 communicate with each other. Specifically, the abnormality determination unit 42 determines whether or not the watercraft controller 40 receives the radio wave transmitted from the communication tag 90. When determining that the watercraft controller 40 receives the radio wave from the communication tag 90 and the communication tag 90 and the watercraft controller 40 are communicated with each other, the abnormality determination unit 42 recognizes that the communication tag 90 is mounted on the watercraft body 11. The abnormality determination unit 42 also recognizes the number of communication tags 90 mounted on the watercraft body 11 based on the number of types of radio waves emitted from the communication tags 90.

Next, the abnormality determination unit 42 determines whether or not a mounted object including a passenger has fallen overboard from the watercraft body 11 (step S2).

Specifically, the abnormality determination unit 42 determines that the mounted object has fallen overboard when at least one condition of the following overboard determination conditions 1 to 5 is satisfied.

<Overboard determination condition 1> The stop switch 19 is switched to on.

<Overboard determination condition 2> The pressure applied to the seat 14 detected by the seat pressure sensor SN3 decreases by equal to or greater than a predetermined determination seat pressure with respect to the initial seat pressure.

<Overboard determination condition 3> The pressure applied to the rear floor part 15 detected by the rear floor part 15 decreases by equal to or greater than a predetermined determination rear floor pressure with respect to the initial rear floor pressure.

<Overboard determination condition 4> In a state where it is recognized in step S1 that the communication tag 90 is mounted on the watercraft body 11, the communication speed between the communication tag 90 and the watercraft controller 40 decreases to equal to or less than a predetermined determination communication speed.

<Overboard determination condition 5> In a state where it is recognized in step S1 that the communication tag 90 is mounted on the watercraft body 11, the radio field intensity of the communication tag 90 received by the watercraft controller 40 decreases to equal to or less than a predetermined determination intensity.

The determination seat pressure, the determination rear floor pressure, the determination communication speed, and the determination intensity are set in advance and stored in the watercraft controller 40. In a case where it is recognized in step S1 that the plurality of communication tags 90 are mounted on the watercraft body 11, it is determined that the overboard determination condition 4 is satisfied when the communication speed of at least one communication tag 90 decreases to equal to or less than the determination communication speed. In a case where it is recognized in step S1 that the plurality of communication tags 90 are mounted on the watercraft body 11, it is determined that the overboard determination condition 5 is satisfied when the radio field intensity of at least one communication tag 90 decreases to equal to or less than the determination intensity.

The fact that the stop switch 19 is switched to on after the end of the sliding preparation period described above means that the tether 101 has come off from the stop switch 19. Therefore, at the time point when the overboard determination condition 1 is satisfied, it can be determined that the driver M1 has fallen overboard.

The fact that after the end of the sliding preparation period, the pressure applied to the seat 14 has been significantly reduced relative to the initial seat pressure detected during the sliding preparation period means that the weight of the object placed on the seat 14 has been significantly reduced after the end of the sliding preparation period. Therefore, at the time point when the overboard determination condition 2 is satisfied, it can be determined that at least a part of the mounted object placed on the seat 14 has fallen overboard. Similarly, the fact that after the end of the sliding preparation period, the pressure applied to the rear floor part 15 has been significantly reduced with respect to the initial rear floor pressure detected in the sliding preparation period means that the weight of the object placed on the rear floor part 15 has been significantly reduced after the end of the sliding preparation period. Therefore, at the time point when the overboard determination condition 3 is satisfied, it can be determined that at least a part of the mounted object placed on the rear floor part 15 has fallen overboard.

The fact that the communication speed between the communication tag 90 recognized as being mounted on the watercraft body 11 and the watercraft controller 40 is low or the radio field intensity of the communication tag 90 received by the watercraft controller 40 is low means that the distance between the communication tag 90 and the small watercraft 10 has been separated by equal to or greater than a predetermined distance after the end of the sliding preparation period. Therefore, at the time point when the overboard determination condition 4 or the overboard determination condition 5 is satisfied, it can be determined that the communication tag 90 or the mounted object to which the communication tag 90 is attached has fallen overboard.

Thus, the tether 101 and the stop switch 19 function as an overboard detection unit that detects falling overboard of a mounted object. A detection unit that detects the communication speed between the watercraft controller 40 and the communication tag 90 and the radio field intensity from the communication tag 90 included in the watercraft controller 40 also functions as an overboard detection unit that detects falling overboard of a mounted object. That is, the watercraft controller 40 functionally includes a detection unit that detects the communication speed between the watercraft controller 40 and the communication tag 90 and the radio field intensity from the communication tag 90, and the detection unit also functions as an overboard detection unit.

If the determination is YES in step S2 and it is confirmed that the mounted object has fallen overboard, the abnormality determination unit 42 determines that an abnormality has occurred in the small watercraft 10 and starts transmitting an abnormality occurrence signal to the communication terminal 50 (step S4). At this time, the abnormality determination unit 42 transmits the abnormality occurrence signal to the communication terminal 50 by wireless communication not via the base station. Due to this, an abnormality occurrence signal is transmitted from the watercraft controller 40 of the small watercraft 10 in which the abnormality has occurred to the communication terminal 50 mounted on the small watercraft 10 in which the abnormality has occurred.

On the other hand, if the determination is NO in step S2 and falling overboard of the mounted object is not confirmed, the abnormality determination unit 42 determines whether or not the small watercraft 10 has been brought into an inoperable state (step S3).

Specifically, when at least one of the following inoperability determination conditions 1 and 2 is satisfied, the abnormality determination unit 42 determines that a mounted object has fallen overboard.

<Steering incapability determination condition 1> The remaining amount of fuel in the fuel tank 24 detected by the fuel tank sensor SN5 is equal to or less than a determination fuel amount close to 0 set in advance.

<Steering incapability determination condition 2> The capacity of the battery 23 detected by the battery sensor SN6 is equal to or less than a determination capacity close to 0% set in advance.

The determination fuel amount and the determination capacity are set in advance and stored in the watercraft controller 40.

The fuel amount in the fuel tank 24 being substantially 0 means that the small watercraft 10 is incapable of navigating. Therefore, at the time point when the steering incapability determination condition 1 is satisfied, it can be determined that the small watercraft 10 has become incapable of steering. The capacity of the battery 23 being substantially 0 means that electric equipment such as the shift motor 38 is incapable of driving. Therefore, at the time point when the steering incapability determination condition 2 is satisfied, it can be determined that the small watercraft 10 has become incapable of appropriate steering. Thus, the fuel tank sensor SN5 and the battery sensor SN6 function as an inoperable state detection unit that detects that the small watercraft has been brought into an inoperable state.

If the determination is YES in step S3 and it is confirmed that the small watercraft 10 has been brought into an inoperable state, the abnormality determination unit 42 proceeds to step S4, determines that an abnormality has occurred in the small watercraft 10, and starts transmitting an abnormality occurrence signal to the communication terminal 50. As described above, at this time, an abnormality occurrence signal is transmitted from the watercraft controller 40 of the small watercraft 10 in which the abnormality has occurred to the communication terminal 50 mounted on the small watercraft 10 in which the abnormality has occurred.

On the other hand, if the determination is NO in step S3, that is, if no mounted object has fallen overboard and the small watercraft 10 is in an operable state, the abnormality determination unit 42 returns to step S2.

After step S4, the normality return determination unit 43 of the watercraft controller 40 determines whether or not the abnormality generated in the small watercraft 10 has been eliminated and the small watercraft 10 has been returned to normal (step S5). Specifically, the normality return determination unit 43 determines that the small watercraft 10 has been returned to normal when all of the following return determination conditions 1 to 3 are satisfied.

<Return determination condition 1> The steering incapability determination condition 1 is not satisfied.

<Return determination condition 2> The steering incapability determination condition 2 is not satisfied.

<Return determination condition 3> A predetermined return operation set in advance is performed on the start switch 18.

The return operation described above is an operation different from the operation performed at the time when starting the engine 30 normally. For example, the return operation is a so-called long press operation of pressing the start switch 18 for equal to or greater than a predetermined time, an operation of pressing the start switch 18 a plurality of times within a predetermined time, or the like. In addition to or instead of the return determination condition 3, a condition that each of the overboard determination conditions 4 is not satisfied may be used.

Next, the watercraft controller 40 waits for the small watercraft 10 to return to normal. If the determination is YES in step S5 and the watercraft controller 40 confirms that the small watercraft 10 has returned to normal, the watercraft controller 40 stops the transmission of the abnormality occurrence signal and transmits a normality return signal to the communication terminal 50 (step S6). At this time, similarly to the abnormality occurrence signal, the watercraft controller 40 transmits also the normality return signal to the communication terminal 50 by wireless communication not via the base station. Due to this, the controller 40 of the small watercraft 10 that has returned to normal transmits a normality return signal to the communication terminal 50 mounted on the small watercraft 10 that has returned to normal.

Next, the watercraft controller 40 determines whether or not the navigation of the small watercraft 10 has ended (step S7), Specifically, the watercraft controller 40 determines whether or not the navigation of the small watercraft 10 has ended and the small watercraft 10 has returned to the port. For example, the watercraft controller 40 performs this determination based on operation of the stop switch 19 or the like. When the determination is YES in step S7 and the navigation of the small watercraft 10 ends, the watercraft controller 40 ends the processing. On the other hand, if the determination is NO in step S7 and the navigation of the small watercraft 10 has not ended, the controller 40 returns to step S2. Thus, the watercraft controller 40 repeats the processing of steps S2 to S7 from the start of the sliding of the small watercraft 10 to the end of the navigation.

### (Control by Communication Terminal Mounted on Small Watercraft)

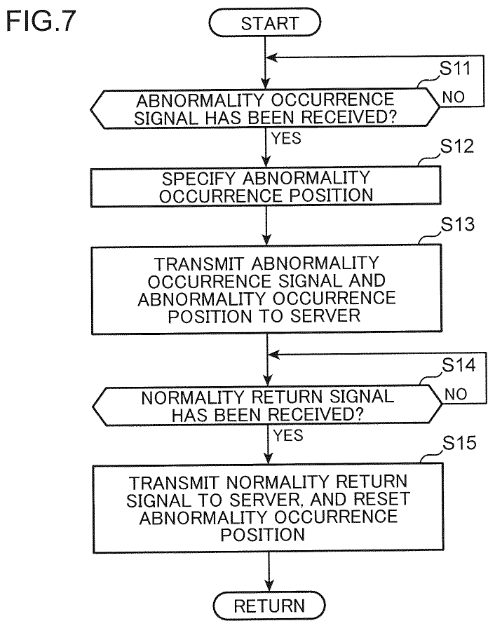

The control illustrated in the flowchart of FIG. 7 is performed by the terminal controller 51 mounted on the small watercraft 10. In the following description of the control according to FIG. 7, the terminal controller 51 mounted on the small watercraft 10 is referred to as watercraft-mounted terminal controller 51 as appropriate. When communication with the small watercraft 10 is started, the watercraft-mounted terminal controller 51 starts the control illustrated in FIG. 7. For example, when the separation distance between the watercraft-mounted terminal controller 51 and the watercraft controller 40 becomes equal to or less than a communicable distance, communication between the watercraft-mounted terminal controller 51 and the watercraft controller 40 is started, and the control in FIG. 7 is started.

When the control in FIG. 7 is started, the watercraft-mounted terminal controller 51 determines whether or not an abnormality occurrence signal transmitted from the watercraft controller 40 has been received (step S11).

If the determination is NO in step S11 and the abnormality occurrence signal has not been received, the watercraft-mounted terminal controller 51 returns to step S11.

On the other hand, if the determination is YES in step S11 and the abnormality occurrence signal is received, the position specification unit 52 of the watercraft-mounted terminal controller 51 specifies the abnormality occurrence position, which is the position where the abnormality has occurred in the small watercraft 10 (step S12). Specifically, the position specification unit 52 specifies the current position of the communication terminal 50 at the time of performing step S12, that is, the current position of the communication terminal 50 including the position specification remit 52 itself, and sets this current position as the abnormality occurrence position. The time from when step S11 is performed to when step S12 is performed is short. The communication time between the watercraft controller 40 and the communication terminal 51 capable of communicating therewith is short. The time from when the determination in step S2 or step S3 becomes YES in the watercraft controller 40 to when step S4 is performed is also short. Due to this, the current position of the position specification unit 52 when step S12 is performed becomes substantially the same as the position when the determination in step S2 or step S3 becomes YES, and is the position where the abnormality has occurred in the small watercraft 10. As described above, the position specification unit 52 specifies the current position by, for example, GPS. Here, the above steps S11 and S12 correspond to the step of “specifying, by the position specification unit, an abnormality occurrence position which is a position where an abnormality has occurred in the small watercraft” in the present disclosure.

Next, the transmission unit 53 of the watercraft-mounted terminal controller 51 transmits an abnormality occurrence signal and an abnormality occurrence position to the server 70 (step S13). As described above, the transmission unit 53 wirelessly connects to the network N and transmits the signal/information to the server 70 via the network N.

Next, the watercraft-mounted terminal controller 51 determines whether or not a normality return signal transmitted from the watercraft controller 40 has been received (step S14).

If the determination is NO in step S14 and no normality return signal has been received, the watercraft-mounted terminal controller 51 returns to step S14.

On the other hand, if the determination is YES in step S14 and the normality return signal has been received, the transmission unit 53 of the watercraft-mounted terminal controller 51 transmits the normality return signal to the server 70 (step S15). The position specification unit 52 resets the abnormality occurrence position specified in step S12 (step S15). Specifically, at the time of performing step S12, the position specification unit 52 stores the abnormality occurrence position, and deletes the stored information on the abnormality occurrence position. After performing step S16, the watercraft-mounted terminal controller 51 returns to step S11.

### (Control in Server)

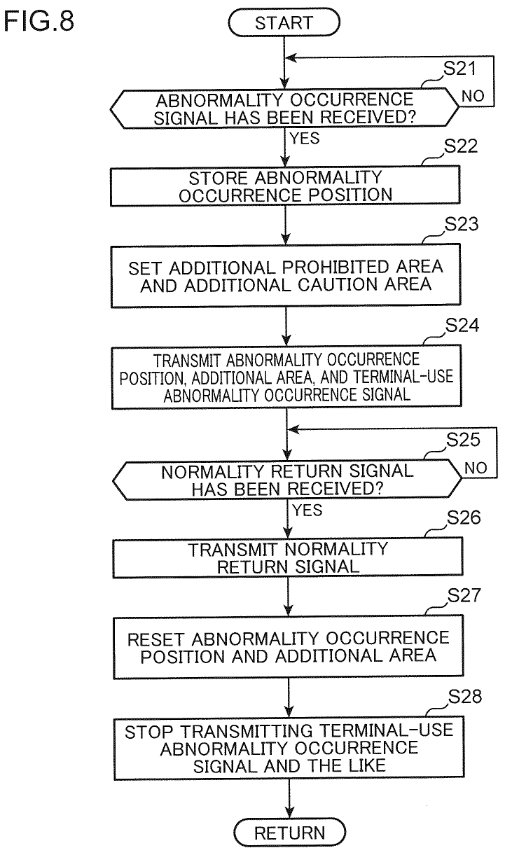

The control illustrated in the flowchart of FIG. 8 is performed by the server 70.

When the control in FIG. 8 is started, the server 70 determines whether or not the abnormality occurrence signal transmitted from the communication terminal 50 to the server 70 has been received (step S21). That is, the server 70 determines whether or not an abnormality occurrence signal has been transmitted from the communication terminal 50.

If the determination is NO in step S21 and the abnormality occurrence signal from the communication terminal 50 has not been received, the server 70 returns to step S21.

On the other hand, if the determination is YES in step S21 and upon receiving the abnormality occurrence signal from the communication terminal 50, the storage unit 71 of the server 70 receives and stores the information on the abnormality occurrence position transmitted from the communication terminal 50 (step S22).

Next, the information provision unit 72 of the server 70 sets an additional prohibited area, which is an area including the abnormality occurrence position, and sets an area around the additional prohibited area as an additional caution area (step S23), Specifically, the information provision unit 72 sets, as the additional prohibited area, the area surrounded by a circle having a preset first radius r1 with a radius about the abnormality occurrence position. The position specification unit 52 sets, as the additional caution area, an area in which the additional prohibited area is excluded from the area surrounded by a circle having a preset second radius r2 with a radius about the abnormality occurrence position. The second radius r2 is set to a value larger than the first radius r1. The additional prohibited area and additional caution area that have been set are stored in the storage unit 71. The above-described additional prohibited area corresponds to the “predetermined area” in the present disclosure. The additional caution area corresponds to the “caution area” in the present disclosure.

Next, the information provision unit 72 transmits information on the abnormality occurrence position, the additional prohibited area, and the additional caution area to the communication terminal 50 (step S24). Specifically, based on the information on the abnormality occurrence position stored in step S22, the information provision unit 72 creates data including information on the abnormality occurrence position and information for causing the communication terminal 50 to recognize the position as the abnormality occurrence position. Then, this data is transmitted to the communication terminal 50. Based on the additional prohibited area and additional caution area having been set, the information provision unit 72 creates data including information on these areas and information for causing the communication terminal 50 to recognize these areas as an additional prohibited area and an additional caution area, respectively. Then, this data is transmitted to the communication terminal 50. The information provision unit 72 transmits a terminal-use abnormality occurrence signal to the communication terminal 50 (step S24). The terminal use abnormality occurrence signal is a signal including information for causing the communication terminal 50 to start processing for causing the user of the communication terminal 50 to recognize the abnormality occurrence position, the processing to be described later. The information provision unit 72 transmits the abnormality occurrence position, information on each addition area, and the terminal-use abnormality occurrence signal to all the communication terminals 50. The information provision unit 72 periodically transmits the abnormality occurrence position, information on each addition area, and the terminal-use abnormality occurrence signal to the communication terminal 50.

Here, the data transmitted from the server 70 to the communication terminas 50 and including the abnormality occurrence position and the information for causing the communication terminal 50 to recognize the position as the abnormality occurrence position corresponds to “operation assistance information” in the present disclosure. As described later, the communication terminal 50 displays the abnormality occurrence position on the map by receiving the data including the abnormality occurrence position from the server 70. Due to this, the data including the abnormality occurrence position corresponds to “data for causing a user to recognize an abnormality occurrence position on a map” in the present disclosure. As described later, the communication terminal 50 receives the data including the additional prohibited area and the additional caution area from the server 70, thereby displaying these areas on the map in a mode different from that of the surroundings. Due to this, the data including the additional prohibited area and the additional caution area corresponds to “data for displaying a predetermined area including the abnormality occurrence position to a user on the map in a mode different from a mode around the predetermined area” in the present disclosure. Step S23 corresponds to “the step of creating, by the processing circuit, predetermined operation assistance information based on the abnormality occurrence position, and transmits the created operation assistance information” in the present disclosure.

Next, the information provision unit 72 determines whether or not a normality return signal transmitted to the server 70 from the communication terminal 50 has been received (step S25). That is, the information provision unit 72 determines whether or not the normality return signal has been transmitted from the communication terminal 50.

If the determination is NO in step S25 and the normality return signal has not been received, the information provision unit 72 returns to step S25.

On the other hand, if the determination is YES in step S25 and the normality return signal has been received, the information provision unit 72 transmits the normality return signal to the communication terminals 50 (step S26). The information provision unit 72 transmits the normality return signal to all the communication terminals 50.

Next, the storage unit 71 of the server 70 resets the information on the abnormality occurrence position, the additional prohibited area, and the additional caution area having been stored (step S27). That is, these pieces of information are erased from the storage unit 71. Next, the information provision unit 72 of the server 70 stops transmission of the terminal-use abnormality occurrence signal, the abnormality occurrence position, the additional prohibited area, and the additional caution area to the communication terminals 50 (step S28). Thus, upon receiving the normality return signal from the communication terminal 50, that is, when the abnormality of the small watercraft 10 is eliminated by the normality return determination unit and the small watercraft 10 returns to the normal state, the information provision unit 72 stops transmission of the terminal-use abnormality occurrence signal and the like. Specifically, the information provision unit 72 stops transmission of the terminal-use abnormality occurrence signal, the data including the abnormality occurrence position, and the data including the additional prohibited area and the additional caution area.

### (Control in all Communication Terminals)

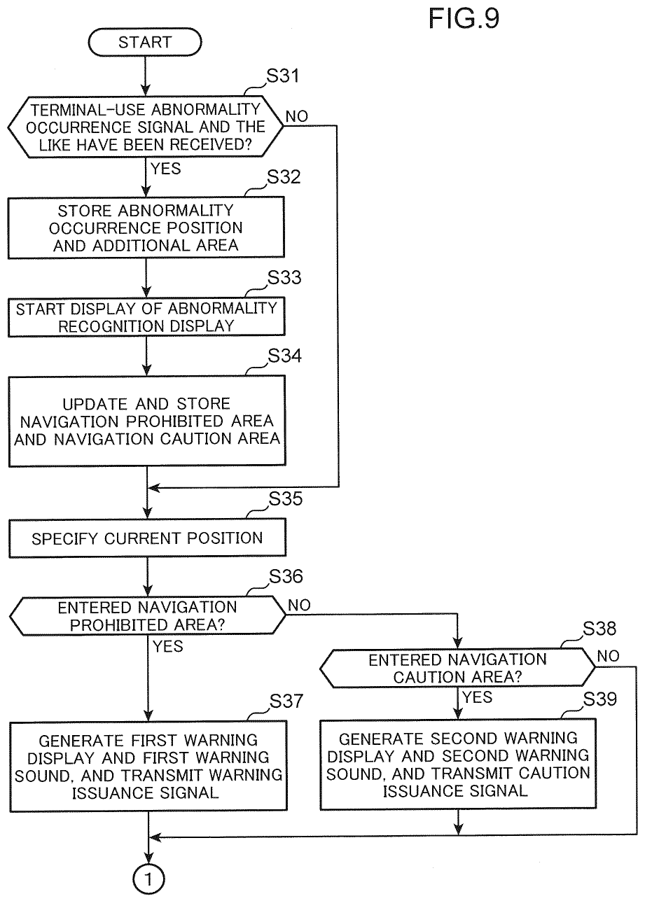

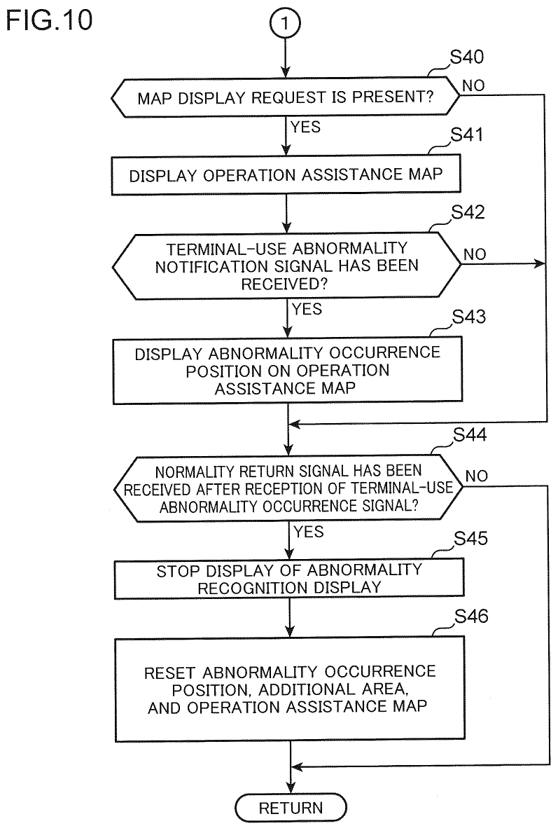

The flowcharts in FIGS. 9 and 10 are control content performed by the assistance control unit 54 of the terminal controller 51 of the communication terminal 50, and illustrate the content of the above operation assistance program. The flowcharts in FIGS. 9 and 10 are performed by the respective terminal controllers 51 of all the communication terminals 50. As described above, the assistance control unit 54 stores the operation assistance map including the basic navigation prohibited area and the basic navigation caution area at the time point when the operation assistance program can be performed. Due to this, at the start of the control in FIG. 9, the operation assistance map is stored in the assistance control unit 54.

When the control in FIG. 9 is started, the assistance control unit 54 determines whether or not the terminal-use abnormality occurrence signal and the information on the abnormality occurrence position and the additional prohibited area and the additional caution area that have been transmitted from the server 70 to the communication terminal 50 have been received (step S31). That is, the terminal controller 51 determines whether or not an abnormality occurrence signal or the like has been transmitted from the server 70. Specifically, in step S31, the assistance control unit 54 determines whether or not the terminal-use abnormality occurrence signal, the data including the abnormality occurrence position, and the data including the additional prohibited area and the additional caution area have been received.

If the determination is NO in step S31 and no abnormality occurrence signal or the like is received, the assistance control unit 54 proceeds to step S35.

On the other hand, if the determination is YES in step S31 and the abnormality occurrence signal or the like is received, the assistance control unit 54 stores the received information on the abnormality occurrence position, the additional prohibited area, and the additional caution area (step S32).

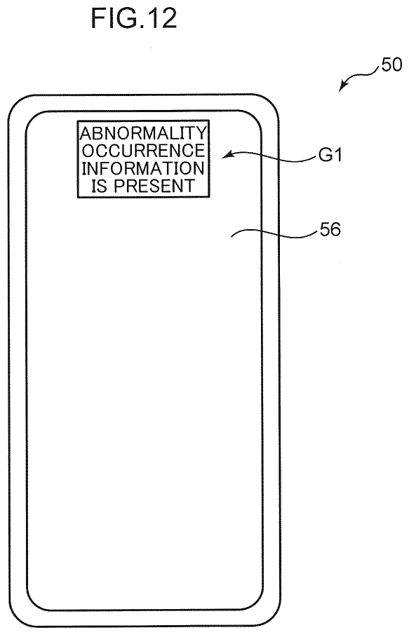

Next, the assistance control unit 54 starts display of abnormality recognition display to the display unit 56 of the communication terminal 50 (step S33). The abnormality recognition display is display for causing the user of the communication terminal 50 to recognize that an abnormality has occurred in the small watercraft 10. FIG. 12 illustrates an example of the abnormality recognition display. In the example of FIG. 12, characters G1 indicating “abnormality occurrence information is present” is displayed on the display unit 56 as the abnormality recognition display. In the example of FIG. 12, the communication terminal 50 includes a substantially rectangular display unit 56.

Next, the assistance control unit 54 updates and stores the navigation prohibited area. Specifically, the assistance control unit 54 stores, as a navigation prohibited area, an area in which the additional prohibited area is added to the stored basic navigation prohibited area (step S34). The assistance control unit 54 updates and stores the navigation caution area. Specifically, the assistance control unit 54 stores, as a navigation prohibited area, an area in which the additional caution area is added to the stored basic navigation caution area (step S34). That is, the assistance control unit 54 sets and stores, as a navigation prohibited area, an area including both the basic navigation prohibited area and the additional prohibited area. The assistance control unit 54 sets and stores, as a navigation caution area, an area including both the basic navigation caution area and the additional caution area.

After step S34 or if the determination is NO in step S31, the terminal controller 51 specifies the current position of the terminal itself, that is, the communication terminal 50 including itself (step S35). This specification is performed by the position specification unit 52. Here, in a case where the communication terminal 50 is mounted on a navigational object, the current position of the communication terminal 50 becomes the current position of the navigational object. Thus, the position specification unit 52 corresponds to the “current position specification unit” that specifies the current position of the navigational object in the present disclosure.

Next, the assistance control unit 54 determines whether or not the assistance control unit 54 itself and the communication terminal 50 including itself have entered a navigation prohibited area (step S36), Specifically, the assistance control unit 54 determines whether or not the current position specified in step S35 is present in the navigation prohibited area. In the communication terminal 50 mounted on a navigational object such as the small watercraft 10, the determination in step S36 becomes the same as determination as to whether or not the navigational object has entered a navigation prohibited area.

If the determination is YES in step S36 and it is determined that the assistance control unit 54 itself has entered a navigation prohibited area, the assistance control unit 54 displays a first warning on the display unit 56 of the communication terminal 50 to warn the user of the communication terminal 50 (step S37). The assistance control unit 54 causes a first warning sound to be generated from the speaker 57 of the communication terminal 50 to warn the user of the communication terminal 50 (step S37). The assistance control unit 54 transmits a warning issuance signal to the outside (step S37). At this time, the assistance control unit 54 transmits the warning issuance signal by wireless communication not via the base station. Due to this, the communication terminal 50 transmits the warning issuance signal to the watercraft controller 40 of the small watercraft 10 that wirelessly communicates with the communication terminal 50.

On the other hand, if the determination is NO in step S36 and it is not determined that the assistance control unit 54 itself has entered a navigation prohibited area, the assistance control unit 54 determines whether or not the assistance control unit 54 itself and the communication terminal 50 including the assistance control unit 54 itself have entered the navigation caution area (step S38). Specifically, the assistance control unit 54 determines whether or not the current position specified in step S35 is present in the navigation caution area. Similarly to step S36, in the communication terminal 50 mounted on a navigational object such as the small watercraft 10, the determination in step S38 becomes the same as the determination as to Whether or not the navigational object has entered the navigation caution area. Here, as described above, the assistance control unit 54 determines whether or not the communication terminal 50, and eventually the navigational object mounted with the communication terminal 50, has entered a navigation prohibited area, and the assistance control unit 54 corresponds to the “determination unit” in the present disclosure.

If the determination is YES in step S38 and it is determined that the assistance control unit 54 itself has entered a navigation caution area, the assistance control unit 54 displays a second warning on the display unit 56 of the communication terminal 50 to warn the user of the communication terminal 50 (step S39). The assistance control unit 54 causes a second warning sound to be generated from the speaker 57 of the communication terminal 50 to warn the user of the communication terminal 50 (step S39). The assistance control unit 54 transmits a caution issuance signal to the outside (step S39). At this time, the assistance control unit 54 transmits the caution issuance signal by wireless communication not via the base station. Due to this, the communication terminal 50 transmits the caution issuance signal to the watercraft controller 40 of the small watercraft 10 that wirelessly communicates with the communication terminal 50. The second first warning display and the first warning display are set to different displays. The first warning sound and the second warning sound are set to sounds different from each other. Specific sounds of the first warning sound and the second warning sound are not limited, but for example, voices are used as the first warning sound and the second warning sound.

Here, when the communication terminal 50 receives a terminal-use abnormality occurrence signal transmitted from the server 70, that is, when an abnormality occurs in the small watercraft 10, the additional prohibited area including the abnormality occurrence position is included in the navigation prohibited area. Due to this, in this case, a warning is given, via the display unit 56 and the speaker 57, to the user of the communication terminal 50 having entered an area including the abnormality occurrence position. When an abnormality occurs in the small watercraft 10, the additional caution area around the additional prohibited area is included in the navigation caution area. Due to this, in this case, a warning is given, via the display unit 56 and the speaker 57, to the user of the communication terminal 50 having approached the additional prohibited area, that is, an area including the abnormality occurrence position. In a case where the user of the communication terminal 50 is a passenger of a navigational object, a warning is issued to the user of this navigational object. Thus, the display unit 56 and the speaker 57 correspond to the “warning unit” in the present disclosure.

After step S37 or step S39 is performed, or if the determination is NO in step S38 and it is determined that the assistance control unit 54 itself has not entered any of the navigation prohibited area and the navigation caution area, the assistance control unit 54 determines whether or not a map display request has been issued (step S40). The map display request is a request issued from the user of the communication terminal 50, and is a request for causing the display unit 56 of the communication terminal 50 to display an operation assistance map. For example, when a predetermined operation is performed on the communication terminal 50, the assistance control unit 54 determines that a map display request has been issued.

If the determination is NO in step S40 and there is no map display request, the assistance control unit 54 proceeds to step S44.

On the other hand, if the determination is YES in step S40 and there is a map display request, the assistance control unit 54 displays the operation assistance map on the display unit 56 of the communication terminal 50 (step S41). At this time, the navigation prohibited area and the navigation caution area are displayed on the operation assistance map (step S41). Specifically, the assistance control unit 54 displays the navigation prohibited area and the navigation caution area on the display unit 56 in modes different from each other and in modes different from a surrounding area of each area.

Here, when step S24 is performed due to reception of the abnormality occurrence signal, the basic navigation prohibited area and the additional prohibited area are displayed as navigation prohibited areas, and the basic navigation caution area and the additional caution area are displayed as navigation caution areas. On the other hand, when step S24 is not performed due to reception of no abnormality occurrence signal, only the basic navigation prohibited area is displayed as a navigation prohibited area, and only the basic navigation caution area is displayed as a navigation caution area.

Next, the assistance control unit 54 determines whether or not the abnormality occurrence signal transmitted from the communication terminal 50 has been received similarly to step S31 (step S42). If the determination is YES in step S42 and the abnormality occurrence signal is received, the assistance control unit 54 displays the abnormality occurrence position stored in step S22 on the operation assistance map displayed on the display unit 56 (step S43). Specifically, the assistance control unit 54 displays, at a position corresponding to the abnormality occurrence position on the operation assistance map displayed on the display unit 56, display for recognition of the abnormality occurrence position. On the other hand, if the determination is NO in step S42 and no abnormality occurrence signal or the like is received, the assistance control unit 54 proceeds to step S44.

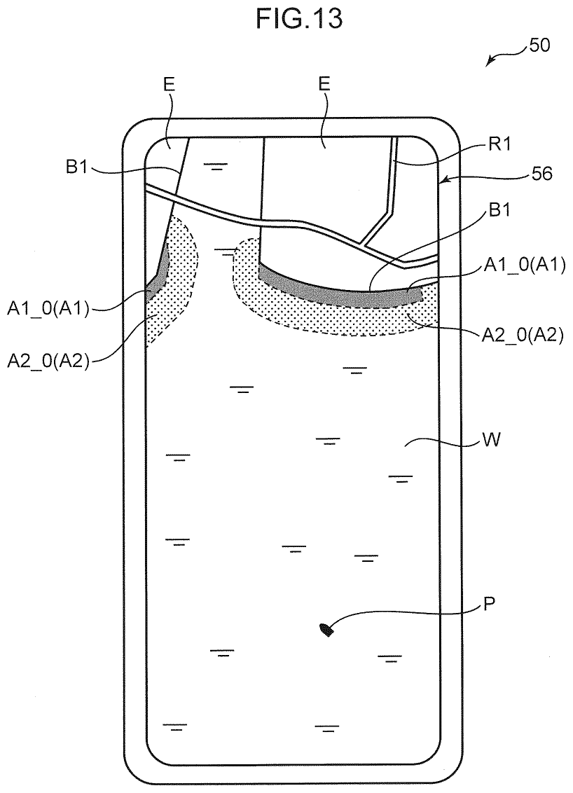

FIGS. 13 to 18 are display examples of the display unit 56 of the communication terminal 50 when a map display request is issued.

FIGS. 13 to 15 are examples of the operation assistance map displayed on the display unit 56 when the small watercraft 10 in which the abnormality has occurred is not present.

FIG. 13 illustrates an example when the communication terminal 50 provided with the display unit 56 illustrated in FIG. 13 has not entered either a navigation prohibited area A1 or a navigation caution area A2. As illustrated in FIG. 13, the display unit 56 presents, as an operation assistance map, a map of coastal land E and a boundary line B1 between the land E and a river, a lake, or a sea W. The display unit 56 presents the navigation prohibited area A1 in a state of being colored. The display unit 56 presents the navigation caution area A2 in a state of being colored in a color different from that of the navigation prohibited area A1. In the example of FIG. 13, an icon P indicating the position of the communication terminal 50 specified in step S35 is displayed. Here, the example of FIG. 13 is an example of a case where there is no small watercraft 10 in which an abnormality has occurred. Due to this, the navigation prohibited area A1 displayed on the operation assistance map is a basic navigation prohibited area A1_0. The navigation caution area. A2 displayed on the operation assistance map is a basic navigation caution area A2_0,

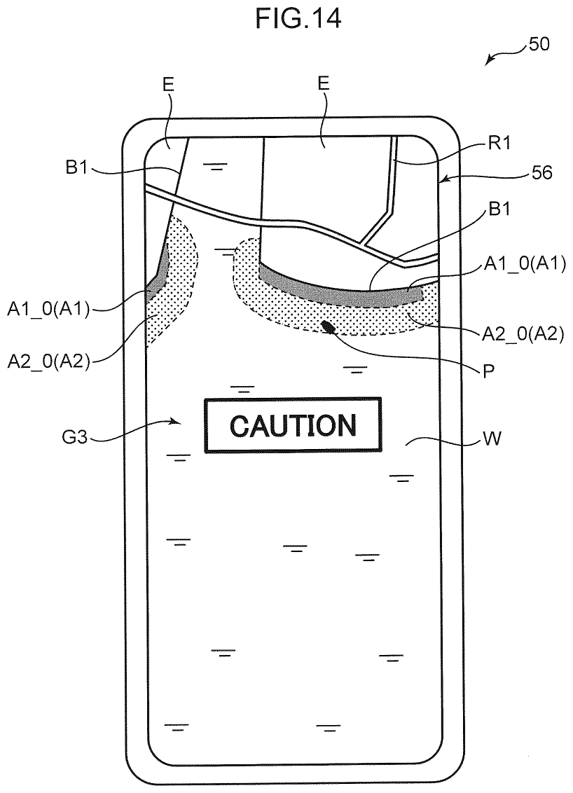

FIG. 14 illustrates an example when the communication terminal 50 enters the navigation caution area A2. As illustrated in FIG. 14, when there is a map display request and the communication terminal 50 enters the navigation caution area A2, an operation assistance map similar to that in FIG. 13 is displayed on the display unit 56. On the other hand, in the example of FIG. 14, as the communication terminal 50 enters the navigation caution area A2 (basic navigation caution area. A2_0), a second warning display is displayed in addition to the operation assistance map on the display unit 56. In the example of FIG. 14, a rectangular frame and characters “caution” arranged in the frame are displayed on the display unit 56 as a second warning display G3. When the communication terminal 50 enters the navigation caution area A2 and there is no map display request, the display unit 56 does not display the operation assistance map but displays only the second warning display G3.

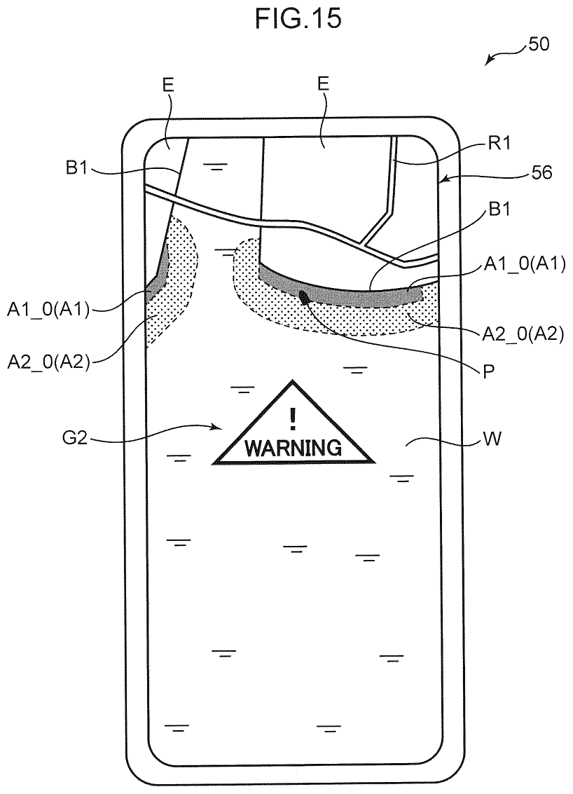

FIG. 15 illustrates an example when the communication terminal 50 enters the navigation prohibited area A1. As illustrated in FIG. 15, when there is a map display request and the communication terminal 50 enters the navigation prohibited area A1, an operation assistance map similar to that in FIG. 13 is displayed on the display unit 56. On the other hand, in the example of FIG. 15, as the communication terminal 50 enters the navigation prohibited area A1 (basic navigation prohibited area A1_0), a first warning display is displayed in addition to the operation assistance map on the display unit 56. In the example of FIG. 15, a triangular frame and characters “!WARNING” arranged in the frame are displayed on the display unit 56 as the first warning display G2. When the communication terminal 50 enters the navigation prohibited area A1 and there is no map display request, the display unit 56 does not display the operation assistance map but displays only the first warning display G2.

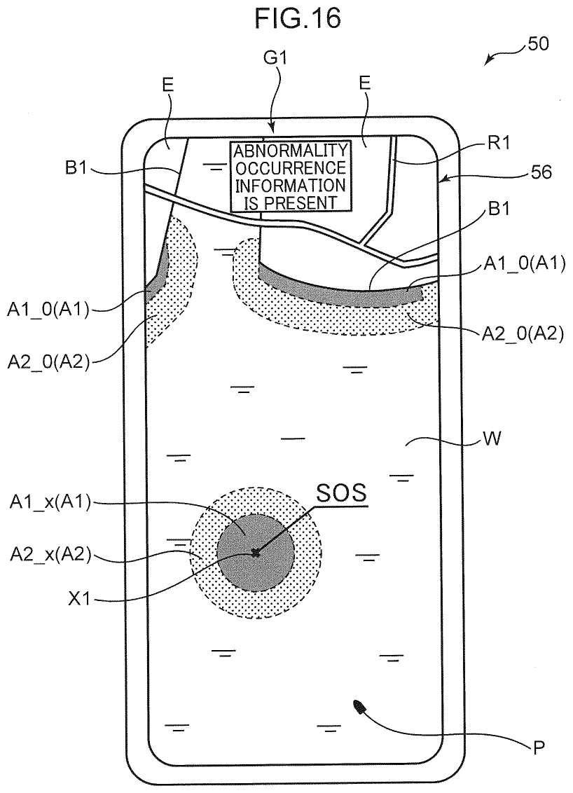

FIGS. 16 to 18 are each examples of the operation assistance map displayed on the display unit 56 when there is the small watercraft 10 in which the abnormality has occurred.

FIG. 16 illustrates an example when the communication terminal 50 has not entered any of the navigation prohibited area A1 and the navigation caution area A2. As illustrated in FIG. 16, when the communication terminal 50 has not entered either the navigation prohibited area A1 or the navigation caution area A2, and there is the small watercraft 10 in which an abnormality has occurred, an abnormality occurrence position X1 is displayed on the operation assistance map similar to that in FIG. 13. In the example of FIG. 16, a figure of “×” indicative of the abnormality occurrence position and characters “SOS” are displayed at the abnormality occurrence position X1. As illustrated in FIG. 16, when there is the small watercraft 10 in which an abnormality has occurred, an additional prohibited area A1_x set around the abnormality occurrence position X1 is displayed as the navigation prohibited area A1 in addition to the basic navigation prohibited area A1_0 displayed also in the example of FIG. 13. In addition to the basic navigation caution area. A2_0 displayed also in the example of FIG. 13, an additional caution area A2_x set around the additional prohibited area A1_x is displayed as the navigation caution area A2. In the example of FIG. 16, the additional prohibited area A1_x and the basic navigation prohibited area A1_0 are displayed in the mode same as each other. The additional caution area A2_x and the basic navigation caution area A2_0 are displayed in the mode same as each other. Also in the example of FIG. 16, similarly to FIG. 13, the icon P is displayed at the current position of the communication terminal 50. Also in the example of FIG. 16, since there is the small watercraft 10 in which the abnormality has occurred, an abnormality recognition display G1 (characters indicating “abnormality occurrence information is present”) is displayed on the display unit 56 similarly to FIG. 12.

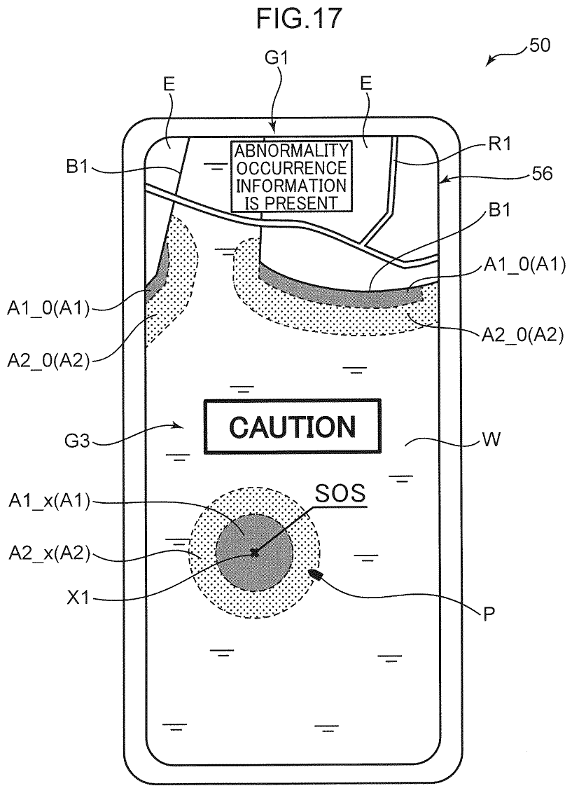

FIG. 17 illustrates an example when the communication terminal 50 enters the navigation caution area A2, As illustrated in FIG. 17, when there is the small watercraft 10 in which an abnormality has occurred and the communication terminal 50 enters the navigation caution area. A2, similarly to FIG. 16, the basic navigation prohibited area A1, the basic navigation caution area A2, the additional prohibited area A1_x, the additional caution area. A2_x, the abnormality occurrence position X1, and the abnormality recognition display G1 are displayed on the operation assistance map. Furthermore, in the example of FIG. 17, as the communication terminal 50 enters the navigation caution area A2, the second warning display G3 (rectangular frame and characters “caution” arranged in the frame) is displayed on the operation assistance map. FIG. 17 illustrates an example when the communication terminal 50 enters the additional caution area A2_x of the navigation caution area A2,

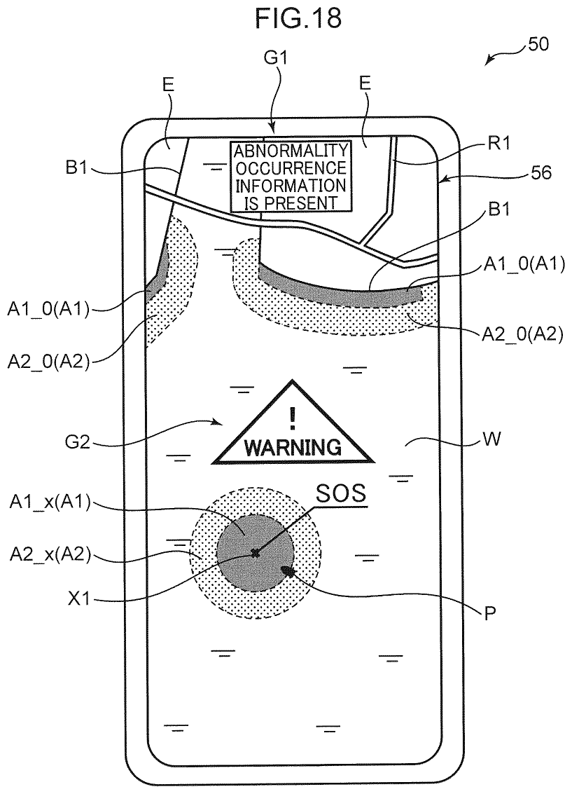

FIG. 18 illustrates an example when the communication terminal 50 enters the navigation prohibited area A1. As illustrated in FIG. 18, when there is the small watercraft 10 in which an abnormality has occurred and the communication terminal 50 enters the navigation caution area A1, similarly to FIG. 16, the basic navigation prohibited area A1, the basic navigation caution area A2, the additional prohibited area A1_x, the additional caution area A2_x, the abnormality occurrence position X1, and the abnormality recognition display G1 are displayed on the operation assistance map. Furthermore, in the example of FIG. 18, as the communication terminal 50 enters the navigation caution area A1, the first warning display G2 (triangular frame and characters “!WARNING” arranged in the frame) is displayed on the operation assistance map. FIG. 18 illustrates an example when the communication terminal 50 enters the additional prohibited area A1_x of the navigation caution area A1.

As illustrated in the flowchart of FIG. 10, after step S43 or if the determination is NO in step S40 or step S42, the assistance control unit 54 determines whether or not the condition that a normality return signal transmitted from the server 70 to the communication terminal 50 is received after reception of a terminal-use abnormality occurrence signal is satisfied (step S44). That is, the assistance control unit 54 determines whether or not the normality return signal has been transmitted after the terminal-use abnormality occurrence signal is transmitted from the server 70 to the communication terminal 50.

If the determined is NO in step S44 and it is not after reception of the terminal-use abnormality occurrence signal or if the normality return signal from the server 70 is not received, the assistance control unit 54 ends the processing and returns to step S1.

On the other hand, if the determination is YES in step S44 and the normality return signal is received after reception of the abnormality occurrence signal, the assistance control unit 54 stops the display of the abnormality recognition display on the display unit 56 (step S45). Due to this, the abnormality recognition display is displayed on the display unit 56 from when the communication terminal 50 receives the terminal-use abnormality occurrence signal from the server 70 to when the normality return signal is received from the server 70.

Next, the assistance control unit 54 resets the information on the abnormality occurrence position, the additional prohibited area, and the additional caution area having been stored (step S46). That is, these pieces of information are erased from the storage. The assistance control unit 54 resets the operation assistance map. Specifically, the additional prohibited area and the additional caution area are erased from the operation assistance map. Due to this, the operation assistance map is reset to the operation assistance map including only the basic navigation prohibited area as the navigation prohibited area and including only the basic navigation caution area as the navigation caution area. After step S46, the assistance control unit 54 returns to step S1.

### (Control of Watercraft Controller)

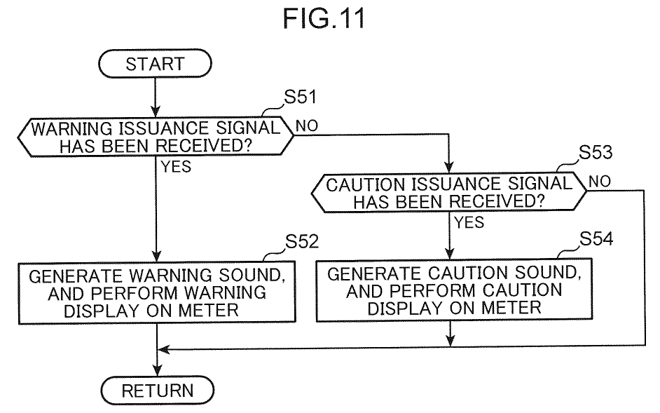

The control illustrated in the flowchart of FIG. 11 is performed by the watercraft controller 40, which is the controller 40 of the small watercraft 10 communicating with the communication terminal 50.

When the control in FIG. 11 is started, the watercraft controller 40 determines whether or not the warning issuance signal transmitted from the communication terminal 50 is received (step S51). As described above, the communication terminal 50 transmits a warning issuance signal to the watercraft controller 40 of the small watercraft 10 that wirelessly communicates with the communication terminal 50.

If the determination is YES in step S51 and the warning issuance signal is received, the watercraft controller 40 generates the first warning sound from the alarm 25 (step S52). The watercraft controller 40 performs the first warning display on the display panel 16 of the small watercraft 10 provided with the watercraft controller 40 itself. For example, display similar to the first warning display displayed on the display unit 56 of the communication terminal 50 is performed on the display panel 16.

On the other hand, if the determination is NO in step S5.1 and no warning issuance signal is received, it is determined whether or not a warning issuance signal transmitted from the communication terminal 50 is received (step S53), As described above, the communication terminal 50 transmits a caution issuance signal to the watercraft controller 40 of the small watercraft 10 that wirelessly communicates with the communication terminal 50.

If the determination is YES in step S53 and the caution issuance signal is received, the watercraft controller 40 generates the second warning sound from the alarm 25 (step S54). The watercraft controller 40 performs the second first warning display on the display panel 16 of the small watercraft 10 provided with the watercraft controller 40 itself. The second warning sound and the first warning sound emitted from the alarm 25 are set to different sounds. The second first warning display and the first warning display displayed on the display panel 16 are set to different displays. For example, display similar to the second first warning display displayed on the display unit 56 of the communication terminal 50 is performed on the display panel 16.

As described above, when the communication terminal 50 communicates with the small watercraft 10, in addition to the display unit 56 and the speaker 57 of the communication terminal 50, the display panel 16 of the small watercraft 10 and the alarm 25 function as a warning unit that issues a warning to the user who has entered a navigation prohibited area including an additional prohibited area and a navigation caution area including an additional caution area.

If the determination is NO in step S53 and neither the warning issuance signal nor the caution issuance signal has been received, the watercraft controller 40 ends the processing as it is and returns to step S51.

### [Operations and Effects]

As described above, in the above-described embodiment, when an abnormality occurs in the small watercraft TO, the abnormality occurrence position, which is the position where the abnormality has occurred, is specified, and the information on the abnormality occurrence position is stored in the storage unit 71 of the server 70. Then, based on the information on the abnormality occurrence position having been stored, the information provision unit 72 of the server 70 creates and transmits, to the communication terminal 50, data including the abnormality occurrence position and information for causing the communication terminal 50 to recognize the position as the abnormality occurrence position.

This can cause the user of the communication terminal 50 to recognize the fact that there is the small watercraft 10 in which an abnormality has occurred and the position where the abnormality has occurred. Therefore, in a case where the user of the communication terminal 50 is on a navigational object such as another small watercraft, it is possible to prevent the navigational object from navigating near the small watercraft 10 in which the abnormality has occurred without noticing that the abnormality has occurred in the small watercraft 10. For example, if a passenger of the small watercraft 10 falls overboard, it is possible to prevent the navigational object from navigating around the passenger fallen overboard without noticing the passenger. It becomes possible to assist a user or the like of another navigational object in rescuing the small watercraft in which an abnormality has occurred.

In particular, in the above-described embodiment, the abnormality occurrence position is displayed on the operation assistance map displayed on the display unit 56 of the communication terminal 50. Therefore, it is possible to cause the user of the communication terminal 50 to intuitively recognize the abnormality occurrence position.

In the above-described embodiment, an additional caution area is set around an additional prohibited area including the abnormality occurrence position. Information on the additional caution area is transmitted from the server 70 to the communication terminal 50. Then, in response to this information, the additional caution area is displayed in a mode different from that of the surrounding area on the operation assistance map displayed on the display unit 56 of the communication terminal 50. Therefore, it is possible to cause the user of the navigational object to intuitively recognize an area around the additional prohibited area including the abnormality occurrence position, the area where attention is required for navigation. Therefore, it is possible to cause the user of the navigational object to intuitively recognize an area around the abnormality occurrence position, the area where attention is required for navigation.

Furthermore, in the above-described embodiment, the second warning display is displayed on the display unit 56 of the communication terminal 50 that has entered the additional caution area, and the second warning sound is emitted from the speaker 57 of the communication terminal 50. That is, when a user in a state of carrying the communication terminal 50 on board a navigational object enters the additional caution area and approaches the abnormality occurrence position, a warning is issued to the user. Therefore, it is possible to prevent the above-described navigational object from inadvertently approaching the abnormality occurrence position.

In the above-described embodiment, information on the additional prohibited area is transmitted from the server 70 to the communication terminal 50. Then, in response to this information, the additional prohibited area is displayed in a mode different from that of the surrounding area on the operation assistance map displayed on the display unit 56 of the communication terminal 50. Therefore, it is possible to cause the user of the navigational object to intuitively recognize an area including the abnormality occurrence position, the area where attention is particularly required for navigation.

Furthermore, in the above-described embodiment, the first warning display is displayed on the display unit 56 of the communication terminal 50 that has entered the additional prohibited area, and the first warning sound is emitted from the speaker 57 of the communication terminal 50. That is, when a user in a state of carrying the communication terminal 50 on board a navigational object enters an additional prohibited area and approaches the abnormality occurrence position, a warning is issued to the user. Therefore, it is possible to prevent the above-described navigational object from inadvertently approaching the abnormality occurrence position.

In particular, in the above-described embodiment, the first warning display and the second warning display are displayed differently, and the first warning sound and the second warning sound are different sounds. Therefore, it is possible to cause the user of the navigational object having passed through the additional caution area and reached the additional prohibited area to recognize that the navigational object has approached more the abnormality occurrence position.

### [Modification]

In the above-described embodiment, a case has been described in which the operation assistance map is displayed on the display unit 56 of the communication terminal 50 only when the determination is YES in step S40 and a map display request is issued. Alternatively, when the terminal-use abnormality occurrence signal is received, the operation assistance map may be displayed on the display unit 56 of the communication terminal 50 regardless of the presence or absence of a map display request. Furthermore, the operation assistance map may be displayed on the display unit 56 of the communication terminal 50 at all times regardless of the presence or absence of a map display request.

In the above-described embodiment, a case of determining whether or not the small watercraft 10 is in a steering incapability state based on the detection values of the fuel tank sensor SN5 and the battery sensor SN6 has been described. Alternatively or in addition to this, it may be determined that the small watercraft 10 is brought into an inoperable state also when the following conditions are satisfied: a condition that the operation amount of the accelerator 17 is equal to or greater than a predetermined amount and the sliding speed detected by the speed sensor SN7 is less than a predetermined value; or a condition that the operation amount of the accelerator 17 is less than a predetermined amount and the sliding speed detected by the speed sensor SN7 is equal to or greater than a predetermined value.

A specific determination configuration as to whether or not a mounted object on the small watercraft 10 has fallen overboard is not limited to the configuration described in the above-described embodiment. For example, an optical sensor may be used to determine falling overboard on a mounted object.

In the above-described embodiment, a case has been described in which an area including the abnormality occurrence position is set as an additional prohibited area and an area around the additional prohibited area is set as a caution area, and a warning is issued to the user of the communication terminal 50 when the communication terminal 50 is present in these areas. Alternatively, a warning may be issued only when the communication terminal 50 is present in one of the additional prohibited area and the additional caution area. As a condition for issuing a warning, instead of the above, a condition that the separation distance between the abnormality occurrence position and the communication terminal 50 becomes equal to or less than a predetermined value may be adopted.

In the above-described embodiment, a case has been described in which the communication terminal 50 to which information such as the abnormality occurrence position is transmitted from the server 70 is a mobile terminal, but the communication terminal 50 is not limited to a terminal that can be carried by the user. For example, the communication terminal 50 may be attached to the navigational object instead of the mobile terminal. In addition to the mobile terminal, communication equipment installed indoors may be used as the communication terminal 50.

In the above-described embodiment, a case has been described in which the warning is issued to the user of the communication terminal 50 from both the display unit 56 and the speaker 57 of the communication terminal 50. Alternatively, a warning may be issued only by one of the display unit 56 and the speaker 57.

In the above-described embodiment, a case has been described in which, as the communication terminal 50 receives data including the abnormality occurrence signal from the server 70, the communication terminal 50 performs control to display the abnormality occurrence position on the operation assistance map. Specifically, in the above-described embodiment, a case has described where the operation assistance program includes a program for displaying the abnormality occurrence position on the operation assistance map, and the operation assistance program is downloaded to the communication terminal 50. Alternatively, the server 70 may transmit, to the communication terminal 50, a program for displaying the abnormality occurrence position on the operation assistance map in accordance with reception of an abnormality occurrence signal.

In the small watercraft 10 included in the operation assistance system 1, the abnormality determination unit 42 and the normality return determination unit 43 may be omitted, and the control according to the flowcharts in FIGS. 6 to 8, steps S31 to S34 in FIG. 9, and steps S42 to S46 in FIG. 10 may be omitted in the control performed by the operation assistance system 1.

In the above-described embodiment, an example has been described in which the present disclosure is applied to the three-passenger small watercraft 10 on which the two passengers M2 in addition to the driver M1 can be on board. However, the small watercraft to which the present disclosure can be applied is not limited to such a three-passenger small watercraft. For example, the present disclosure can be similarly applied to a two-passenger small watercraft on which one passenger in addition to the driver can be on board, and a small watercraft on which four or more passengers including the driver can be on board.

### SUMMARY

The above-described embodiment and its modifications include the following disclosure.

An operation assistance system for a small watercraft according to one aspect of the present disclosure includes: a position specification spit that specifies an abnormality occurrence position, which is a position where an abnormality has occurred, when the abnormality has occurred in a small watercraft: a transmission unit that transmits information on the abnormality occurrence position specified by the position specification unit; and a processing circuit, in which the processing circuit includes a storage unit that stores information on the abnormality occurrence position transmitted from the transmission unit, and an information provision unit that creates predetermined operation assistance information based on information on the abnormality occurrence position stored in the storage unit and transmits the created operation assistance information.

According to the present disclosure, predetermined operation assistance information is transmitted from the processing circuit based on information on the abnormality occurrence position where an abnormality has occurred in the small watercraft. Therefore, it is possible to prevent the user of the navigational object having received the operation assistance information from navigating around a small watercraft in which an abnormality has occurred without noticing that the abnormality has occurred in the small watercraft. It is possible to facilitate the user or the like in rescuing the small watercraft.

Preferably, the operation assistance system further includes a display unit that displays a map for a user of a navigational object other than the small watercraft in which the abnormality has occurred, in which the information provision unit transmits, to the display unit as the operation assistance information, data for causing the user to recognize the abnormality occurrence position on the map.

In this mode, the user can recognize the abnormality occurrence position on the map. This enables the user to intuitively recognize the abnormality occurrence position.

Preferably, the information provision unit transmits, to the display unit, data for displaying a predetermined area including the abnormality occurrence position on the map in a mode different from a mode around the predetermined area.

In this mode, the area including the abnormality occurrence position and the surrounding area are displayed in different modes on the map. Therefore, the user is capable of promptly recognizing the area including the abnormality occurrence position when viewing the map.

Preferably, the operation assistance system further includes a warning unit that issues a warning to a user of a navigational object approaching the predetermined area.

In this mode, a warning is issued to the user of the navigational object approaching the predetermined area including the abnormality occurrence position. Therefore, it is possible to cause the user of another navigational object to recognize presence of a nearby small watercraft in which an abnormality occurs. This makes it possible to prevent the user of another navigational object from navigating near the small watercraft without noticing the small watercraft.

Specifically, it is preferable that the information provision unit sets a predetermined caution area around the predetermined area, and the warning unit issues a warning to the user who has entered the caution area.

In this mode, since a warning is issued to the user having entered a caution area, it is possible to prevent the user of another navigational object from navigating near the small watercraft without noticing the small watercraft.

Preferably, the warning unit issues a warning to the user having entered the predetermined area, in a mode different from a mode of the user having entered the caution area.

In this mode, it is possible to cause the user to recognize approaching the abnormality occurrence position more than that when navigating a caution area.

Preferably, the display unit is provided in a communication terminal capable of communicating with the processing circuit and capable of being carried by the user.

In this mode, data for causing the user carrying the communication terminal to recognize the data on the map is transmitted to the user. This allows the data to be transmitted regardless of the position of the user.

Preferably, the operation assistance system further includes an overboard detection unit that detects falling overboard of a mounted object mounted on a small watercraft, in which when falling overboard of the mounted object is detected by the overboard detection unit, the position specification unit specifies, as the abnormality occurrence position, a position where the falling overboard has occurred.

In this mode, the overboard position of the mounted object mounted on the small watercraft is specified as the abnormality occurrence position. Therefore, it is possible to inform the user or the like of a navigational object including a small watercraft of the overboard position of the mounted object. This makes it possible to prevent another navigational object from navigating near the mounted object having fallen overboard without noticing the presence of the mounted object.

Preferably, the overboard detection unit is capable of detecting a passenger of the small watercraft falling overboard, and when falling overboard of the passenger is detected by the overboard detection unit, the position specification unit specifies, as the abnormality occurrence position, a position where the falling overboard has occurred.

In this mode, when a passenger of the small watercraft falls overboard, this overboard position is specified as the abnormality occurrence position. This makes it possible to prevent another navigational object from navigating near the person having fallen overboard without noticing the presence of the mounted object. The overboard position is notified to the user of a navigational object other than the small watercraft in which the falling overboard has occurred, whereby it becomes possible to promptly rescue the person having fallen overboard.

Preferably, the operation assistance system further includes an inoperable state detection unit that detects that a small watercraft is brought into an inoperable state, in which the position specification unit specifies, as the abnormality occurrence position, a position where the small watercraft is brought into an inoperable state detection when the inoperable state detection unit detects that the small watercraft is brought into an inoperable state.

In this mode, the position of the small watercraft having been brought into an inoperable state is specified as the abnormality occurrence position. This makes it possible to prevent another navigational object from navigating near the small watercraft that is brought into an inoperable state without noticing that there is a possibility that the small watercraft that is brought into an inoperable state. The position of the small watercraft is notified to the user of a navigational object other than the small watercraft that is brought into an inoperable state, whereby it becomes possible to promptly rescue the small watercraft.

Preferably, the operation assistance system further includes an operation unit provided in a small watercraft and operable by a passenger of the small watercraft, and a normality return determination unit that determines whether or not the abnormality has been eliminated based on an operation status of the operation unit, and the information provision unit stops transmission of the operation assistance information when the normality return determination unit determines that the abnormality has been eliminated.

In this mode, it is avoided that operation assistance information is continuously transmitted even after the abnormality is eliminated. This makes it possible to reduce an opportunity for the user of a navigational object other than the small watercraft in which the abnormality has occurred to unnecessarily slow down or the like. Therefore, it is possible to improve convenience of the user of the navigational object.

An operation assistance method for a small watercraft according to another aspect of the present invention is an operation assistance method for a small watercraft, the method for assisting operation of a small watercraft using an operation assistance system including a position specification unit, a transmission unit, and a processing circuit, the method including: a step of specifying, by the position specification unit, an abnormality occurrence position which is a position where an abnormality has occurred in the small watercraft; and a step of creating, by the processing circuit, predetermined operation assistance information based on the abnormality occurrence position, and transmitting the created operation assistance information.

Also by this mode, predetermined operation assistance information is transmitted from the processing circuit based on information on the abnormality occurrence position, which is the position where the abnormality has occurred in the small watercraft. Therefore, it is possible to prevent the user of the navigational object having received the operation assistance information from navigating around a small watercraft in which an abnormality has occurred without noticing that the abnormality has occurred in the small watercraft. It is possible to facilitate the user or the like in rescuing the small watercraft.

An operation assistance system for a small watercraft according to another aspect of the present invention includes: an area storage unit that stores a predetermined navigation prohibited area where entry of a navigational object is prohibited; an information provision unit that sets a navigation caution area around the navigation prohibited area stored in the storage unit; and a warning unit that issues a warning to a user of a navigational object that has entered the navigation caution area.

This mode makes it possible to cause the user of a navigational object having approached a predetermined prohibited area where entry of navigational objects is prohibited to recognize that the navigational object has approached the prohibited area.

1. An operation assistance system for a small watercraft comprising:
a position specification unit that specifies an abnormality occurrence position, which is a position where an abnormality has occurred, when the abnormality has occurred in a small watercraft;
a transmission unit that transmits information on the abnormality occurrence position specified by the position specification unit; and
a processing circuit;
wherein the processing circuit includes
a storage unit that stores information on the abnormality occurrence position transmitted from the transmission unit, and
an information provision unit that creates predetermined operation assistance information based on information on the abnormality occurrence position stored in the storage unit and transmits the created operation assistance information.

2. The operation assistance system for a small watercraft according to claim 1, further comprising a display unit that displays a map for a user of a navigational object other than the small watercraft in which the abnormality has occurred,
wherein the information provision unit transmits, to the display unit as the operation assistance information, data for causing the user to recognize the abnormality occurrence position on the map.

3. The operation assistance system for a small watercraft according to claim 2, wherein the information provision unit transmits, to the display unit, data for displaying a predetermined area including the abnormality occurrence position on the map in a mode different from a mode around the predetermined area.

4. The operation assistance system for a small watercraft according to claim 3, further comprising a warning unit that issues a warning to a user of a navigational object approaching the predetermined area.

5. The operation assistance system for a small watercraft according to claim 4, wherein
the information provision unit sets a predetermined caution area around the predetermined area, and
the warning unit issues a warning to the user who has entered the caution area.

6. The operation assistance system for a small watercraft according to claim 5, wherein the warning unit issues a warning to the user having entered the predetermined area, in a mode different from a mode of the user having entered the caution area.

7. The operation assistance system for a small watercraft according to claim 2, wherein the display unit is provided in a communication terminal capable of communicating with the processing circuit and capable of being carried by the user.

8. The operation assistance system for a small watercraft according to claim 1, further comprising an overboard detection unit that detects frilling overboard of a mounted object mounted on a small watercraft,
wherein when falling overboard of the mounted object is detected by the overboard detection unit, the position specification unit specifies, as the abnormality occurrence position, a position where the falling overboard has occurred.

9. The operation assistance system for a small watercraft according to claim 8, wherein
the overboard detection unit is capable of detecting a passenger of the small watercraft falling overboard, and
when falling overboard of the passenger is detected by the overboard detection unit, the position specification unit specifies, as the abnormality occurrence position, a position where the falling overboard has occurred.

10. The operation assistance system for a small watercraft according to claim 1, further comprising an inoperable state detection unit that detects that a small watercraft is brought into an inoperable state,
wherein the position specification unit specifies, as the abnormality occurrence position, a position where the small watercraft is brought into an inoperable state detection when the inoperable state detection unit detects that the small watercraft is brought into an inoperable state.

11. The operation assistance system for a small watercraft according to claim 1, further comprising:
an operation unit provided in a small watercraft and operable by a passenger of the small watercraft; and
a normality return determination unit that determines whether or not the abnormality has been eliminated based on an operation status of the operation unit,
wherein the information provision unit stops transmission of the operation assistance information when the normality return determination unit determines that the abnormality has been eliminated.

12. An operation assistance method for a small watercraft, the method for assisting operation of a small watercraft using an operation assistance system including a position specification unit, a transmission unit, and a processing circuit, the method comprising:
a step of specifying, by the position specification unit, an abnormality occurrence position which is a position where an abnormality has occurred in the small watercraft; and
a step of creating, by the processing circuit, predetermined operation assistance information based on the abnormality occurrence position, and transmitting the created operation assistance information.

13. An operation assistance system for a small watercraft, the system comprising:
an area storage unit that stores a predetermined navigation prohibited area where entry of a navigational object is prohibited;
an area setting unit that sets a navigation caution area around the navigation prohibited area stored in the storage unit;
a current position specification unit that specifies a current position of a navigational object;
a determination unit that determines whether or not the navigational object has entered the navigation caution area based on the current position of the navigational object specified by the current position specification; and
a warning unit that issues a warning to a user of a navigational object that has entered the navigation caution area when the determination unit determines that the navigational object has entered the navigation caution area.
